(19) United States
(12) Patent Application Publication
(10) Pub. No.: US 2021/0035135 A1
(43) Pub. Date: Feb. 4, 2021

(54) DOMINANT CUSTOMER LOCATIONS IDENTIFICATION SYSTEMS AND METHODS

(71) Applicant: T-Mobile USA, Inc., Bellevue, WA (US)

(72) Inventors: Khrum Kashan Jat, Sammamish, WA (US); Jatinder Singh Sandhu, Bellevue, WA (US); Otto Fonseca Escudero, Snoqualmie, WA (US); Gary Dousson, Seattle, WA (US); Dillon Camp, Bellevue, WA (US); Ahmed Mahdaoui, Bothell, WA (US)

(21) Appl. No.: 16/529,697

(22) Filed: Aug. 1, 2019

(51) Int. Cl. G06Q 30/02; H04W 4/029

(52) U.S. Cl. CPC G06Q 30/0205; H04W 4/029

(57) ABSTRACT

Systems and methods for identifying dominant user locations so that optimum user experience improvement solutions can be deployed at the identified locations are disclosed. One of the purposes of the dominant customer location identification system is to plan for site capacity (for example, small cell planning, hot-spots planning, and dense area capacity planning) and to offer optimum/premium customer experience. The system does this by understanding the customer's dominant locations over a certain period of time (for example, monthly) so that the customer's overall experience can be enhanced. Once a customer's dominant locations are identified, then the telecommunications service provider can gain a better understanding of the primary sites providing service to the customer, and deploy/implement/execute one or more optimum customer experience improvement solutions at the identified sites.

### BACKGROUND

A telecommunications network is established via a complex arrangement and configuration of many cell sites that are deployed across a geographical area. For example, there can be different types of cell sites (e.g., macro cells, microcells, and so on) positioned in a specific geographical location, such as a city, neighborhood, and so on). These cell sites strive to provide adequate, reliable coverage for mobile devices (e.g., smart phones, tablets, and so on) via different frequency bands and radio networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), or other communications networks. The devices can seek access to the telecommunications network for various services provided by the network, such as services that facilitate the transmission of data over the network and/or provide content to the devices.

As device usage continues to rise at an impressive rate, there are too many people using too many network (and/or data)-hungry applications in places where the wireless edge of the telecommunications network has limited or no capacity. As a result, most telecommunications networks have to contend with issues of network congestion. Network congestion is the reduced quality of service that occurs when a network node carries more data than it can handle. Typical effects include queueing delay, packet loss or the blocking of new connections, overall resulting in degraded customer experience.

### BRIEF DESCRIPTION OF THE DRAWINGS

FIG. 1 is a block diagram illustrating a suitable computing environment within which to identify dominant customer locations within a telecommunications network.

FIG. 2 is a block diagram illustrating the components of the dominant customer locations identification system.

FIG. 3 is a flow diagram illustrating a process of identifying dominant customer locations in a telecommunications network.

FIGS. 4A-4C are example flow diagrams illustrating processes (or components of processes) of identifying dominant customer locations in a telecommunications network.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

An aim of a telecommunications service provider is to minimize customer experience degradation. This is typically achieved by deploying congestion management and/or network improvement solutions at one or more cell sites. While existing solutions tackle this problem at a macro level by deploying solutions at congested cell sites, they are unable to tackle problems experienced by individual customers, who move between cell sites. This is primarily because a customer uses their mobile device at multiple different locations during the day, and as a result, connects to several different cell sites. However, typical customers have two or more dominant locations (for example, home and work locations). While the term “customer” is used in the application, one of skill in the art will understand that the concepts discussed herein will similarly apply to other users, who may or may not be customers of a telecommunications service provider.

To solve these and other problems, the inventors have developed a dominant customer location identification system and related method to identify dominant customer locations so that optimum customer experience improvement solutions can be deployed at the identified locations (“dominant location system”). One of the purposes of the dominant location system is to plan for site capacity (for example, small cell planning, hot-spots planning, and dense area capacity planning) and to offer optimum/premium customer experience. The system does this by understanding the customer's dominant locations over a certain period of time (for example, monthly) so that the customer's overall experience can be enhanced. Once a customer's dominant locations are identified, then the telecommunications service provider can gain a better understanding of the primary sites providing service to the customer, and deploy/implement/execute one or more optimum customer experience improvement solutions at the identified sites. For example, the telecommunications service provider can evaluate the sites and implement solutions at the identified sites to ensure that they have enough capacity to provide good coverage to the customer, thus, enhancing the overall customer experience.

The dominant location system improves customer experience by identifying dominant locations of the customer regardless of their known addresses (e.g., home address, billing address, work address, etc.). For each customer, the system collects customer related data, such as location specific records, call data records, timing advance value, application usage data, and so on. The system extracts values of certain parameters for each collected record—location (latitude, longitude), RF signal, data received, data used, time stamp, duration of usage, etc. The system then divides the collected customer data into two or more time-based buckets (for example, 7 am-7 pm, and 7 pm-7 am). For each time-based bucket, the system clusters the records based on the location information associated with the records. For example, the system uses k-means clustering. The system then identifies a location associated with one or more dominant clusters within each time-based bucket. For example, the system identifies one dominant location within a cluster with records generated during 7 am-7 pm (customer's likely work location), and a dominant location with a cluster with records generated during 7 pm-7 am (customer's likely home location). Using the identified dominant locations, the system creates bins (for example, hexagonal bins) and using spatial matching, identifies which hex bin the customer's dominant location belongs to, and the sector covering the identified hex bin. After identifying the sector covering the hex bin where the customer spends a majority of his/her time, the system identifies and deploys one or more measures to improve customer experience for each customer in the identified sector. Examples of customer experience measures include, but are not limited to, adding spectrum, sector additions to reuse spectrum, adding cell sites (macro, micro or small cell), adding technology capabilities (e.g., support for 4G, 5G, etc.), location intelligence based measures, upsales to customers, targeted advertising, special promotions, content only for certain customers, and so on.

In the following description, for the purposes of explanation, numerous specific details are set forth in order to provide a thorough understanding of implementations of the present technology. It will be apparent, however, to one skilled in the art that implementations of the present technology can be practiced without some of these specific details.

The phrases “in some implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Suitable Computing Environments

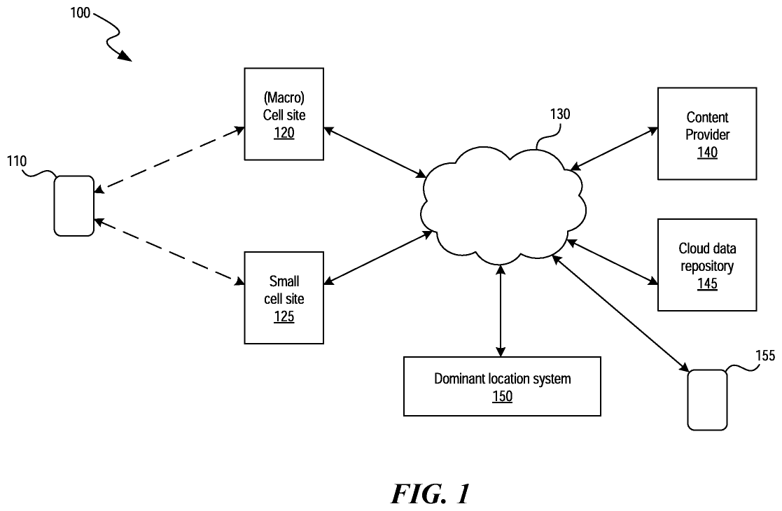

FIG. 1 is a block diagram illustrating a suitable computing environment 100 within which to identifying customer dominant locations to enhance a customer's experience with a telecommunications service provider.

One or more user devices 110, such as mobile devices or user equipment (UE) associated with users (such as mobile phones (e.g., smartphones), tablet computers, laptops, and so on), Internet of Things (loT) devices, devices with sensors, and so on, receive and transmit data, stream content, and/or perform other communications or receive services over a telecommunications network 130, which is accessed by the user device 110 over one or more cell sites 120, 125. For example, the mobile device 110 can access a telecommunication network 130 via a cell site at a geographical location that includes the cell site, in order to transmit and receive data (e.g., stream or upload multimedia content) from various entities, such as a content provider 140, cloud data repository 145, and/or other user devices 155 on the network 130 and via the cell site 120.

The cell sites can include macro cell sites 120, such as base stations, small cell sites 125, such as picocells, microcells, or femtocells, and/or other network access component or sites. The cell cites 120, 125 can store data associated with their operations, including data associated with the number and types of connected users, data associated with the provision and/or utilization of a spectrum, radio band, frequency channel, and so on, provided by the cell sites 120, 125, and so on. The cell sites 120, 125 can monitor their use, such as the provisioning or utilization of physical resource blocks (PRBs) provided by a cell site physical layer in LTE network; likewise the cell sites can measure channel quality, such as via channel quality indicator (CQI) values, etc.

Other components provided by the telecommunications network 130 can monitor and/or measure the operations and transmission characteristics of the cell sites 120, 125 and other network access components. For example, the telecommunications network 130 can provide a network monitoring system, via a network resource controller (NRC) or network performance and monitoring controller, or other network control component, in order to measure and/or obtain the data associated with the utilization of cell sites 120, 125 when data is transmitted within a telecommunications network.

In some implementations, the computing environment 100 includes a dominant location system 150 configured to monitor aspects of the network 130 based on, for example, data received from the network monitoring system. The dominant location system 150 can receive customer usage records to identify one or more locations where a customer mostly uses the services of a telecommunication service provider (customer dominant locations), and then identify one or more services/solutions to enhance the customer's location at the customer's dominant locations.

FIG. 1 and the discussion herein provide a brief, general description of a suitable computing environment 100 in which the dominant location system 150 can be supported and implemented. Although not required, aspects of the dominant location system 150 are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (loT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the user device 110 and/or the cell sites 120, 125 can include network communication components that enable the devices to communicate with remote servers or other portable electronic devices by transmitting and receiving wireless signals using a licensed, semi-licensed, or unlicensed spectrum over communications network, such as network 130. In some cases, the communication network 130 can be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The telecommunications network 130 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), or other communications networks. Thus, the user device is configured to operate and switch among multiple frequency bands for receiving and/or transmitting data.

Further details regarding the operation and implementation of the dominant location system 150 will now be described.

### Examples of Identifying Dominant Customer Locations and Deploying Improved Customer Experience Enhancement Solutions

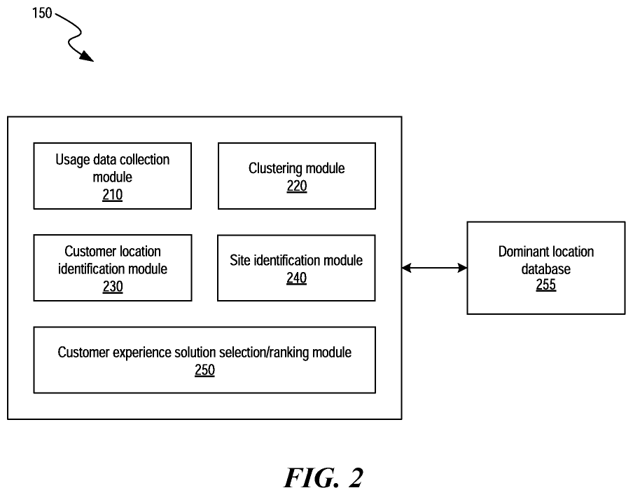

FIG. 2 is a block diagram illustrating the components of the dominant location system 150. The dominant location system 150 can include functional modules that are implemented with a combination of software (e.g., executable instructions, or computer code) and hardware (e.g., at least a memory and processor). Accordingly, as used herein, in some examples a module is a processor-implemented module or set of code, and represents a computing device having a processor that is at least temporarily configured and/or programmed by executable instructions stored in memory to perform one or more of the specific functions described herein. For example, the dominant location system 150 can include a usage data collection module 210, a clustering module 220, a customer location identification module 230, a site identification module 240, and a customer experience solution selection/ranking module 250, each of which is discussed separately below.

### The Usage Data Collection Module

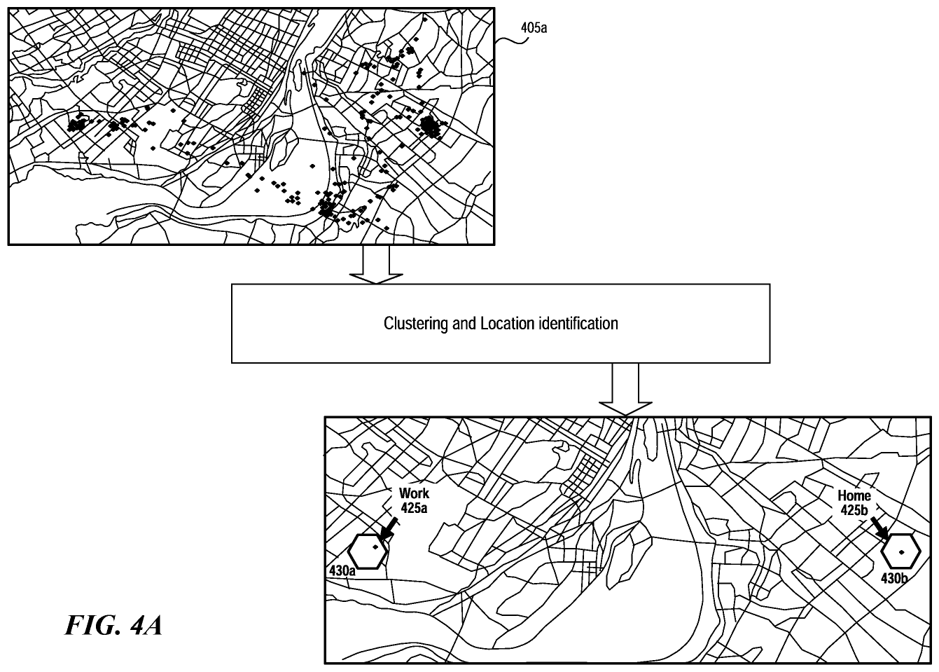

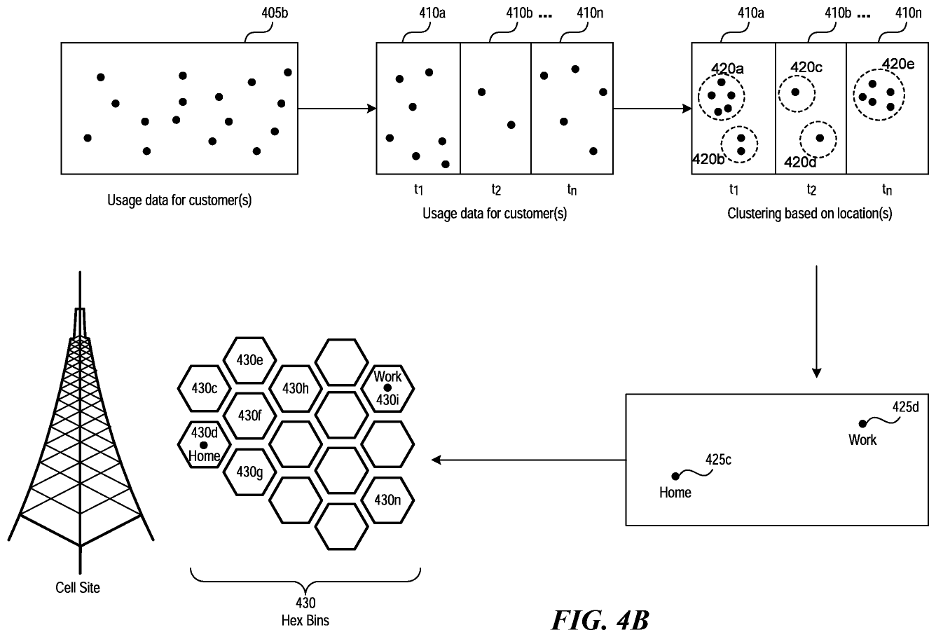

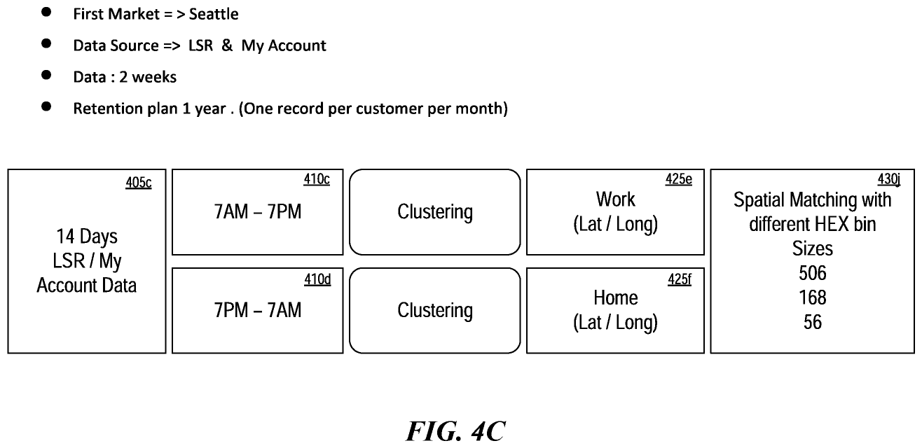

The usage data collection module 210 is configured and/or programmed to receive a customer's usage data when accessing services/utilities associated with a telecommunications network. For example, the usage data collection module 210 collects/receives/accesses one or more of the following usage data records associated with a customer relating to the following types of information (which can be stored in the dominant location database 255): location specific records (LSR), call data records (CDRs), timing advance values, RF signal data, distance between the customer and at least one telecommunications network site, strength of signal, quantity of data used, type of device of the customer, applications data (e.g., application type, name, owner, manager, data sent/received/used/saved, bandwidth used, APIs accessed, etc.), source of usage records (for example, telecommunications service provider, third-party, application owner, etc.). Examples of other types of data collected by the usage data collection module include, but are not limited to, data collected from third party applications (e.g., including crowdsourced data) that can help to determine customer experience with location. For example, the usage data collection module can collect information of a user's location using his/her social media posts (e.g., tweets, check-ins, posts, etc.). As another example, the usage data collection module 210 collects application level data (e.g., collected using applications related to Internet of Things (loT) devices, sensors, billing meters, traffic lights, etc.) to identify the user location and applications used to enhance the location algorithm. FIGS. 4A-4C illustrate examples of usage records 405a, 405b, and 405c that are received by the usage data collection module 210. The usage data records associated with the customer can comprise information about an associated customer location and an associated timestamp. For example, a call data record for a customer can identify a customer location and a timestamp when the call was initiated. The usage data collection module 210 can collect usage records that span a particular period of time depending on, for example, density of usage records, usage activity, types of usage records (for example, text, voice, video, app-usage, emergency services, etc.), services/products to be offered to the customer, types of customer experience enhancement solutions/actions to be implemented, source of usage records, and so on.

### The Clustering Module

The clustering module 220 is configured and/or programmed to identify clusters of the received usage data records in order to glean useful information. In some implementations, the clustering module 220 processes the received usage data to generate a usable set of usage records by, for example, removing noise, outliers, etc. Then, the clustering module 220 divides the usable set of usage data records into time-based subsets based on the associated timestamp of the records in the set of usage data records. For example, the clustering module divides the usage records into two time-based subsets: records generated during day time (e.g., 7 am-7 pm) and records generated during night time (e.g., 7 pm-7 am). The clustering module selects the number and span of the time-based records based on one or more of the following factors: density of usage records, usage activity, user-defined time windows, types of usage records, services/products to be offered to the customer, types of customer experience enhancement solutions/actions to be implemented, source of usage records, and so on. For example, the clustering module 220 generates time-based subsets, each of which reflect a time period of maximum usage activity of the customer. FIGS. 4B-4C illustrate time-based subsets 410a, 410b, 410c, 410d, . . . , 410n that are generated by the clustering module 220.

After generating the time-based subsets, the clustering module 220 generates a set of clusters of usage records data in the time-based subset based on, for example, the location associated with the usage records. In some implementations, the clustering module 220 can use one or more of the following parameters to generate the clusters: duration of usage, usage activity, type of usage records, source of usage records, time of usage, and so on. For example, the clustering module 220 can cluster based on time of usage and type of usage records to identify that applications, such as social media applications and/or video applications are mostly used during the evening and night whereas applications, such as email applications and/or music applications are mostly used during the day.

The clustering module 220 uses techniques like k-means clustering, fuzzy clustering, partitioning, etc. to cluster at least some of the usage records in one or more of the generated time-based subsets. In some implementations, the clustering module generates the clusters for only some, but not all of the time-based subsets. For example, depending on the density of usage records in the time-based subsets, the clustering module 220 selects the top n time-based subsets for each of which it generates the set of clusters. Other factors that can influence the selection of the time-based clusters include, but are not limited to, span of the time-based cluster, usage activity, types of usage records, services/products to be offered to the customer, types of customer experience enhancement solutions/actions to be implemented, source of usage records, and so on. FIG. 4B illustrates location-based clusters 420a, 420b, 420c, 420d, and 420e in time-based subsets 410a, 410b, . . . , 410n that are generated by the clustering module.

### The Customer Location Identification Module

The customer location identification module 230 is configured and/or programmed to identify geographic locations (for example, latitude and longitude) for some or all of the sets of clusters of usage records data generated by the clustering module 220. For the clusters identified in each time-based subset, the customer location identification module 230 selects a particular cluster (for example, a dominant cluster). The customer location identification module 230 can select one or more particular clusters based on the following factors: density of usage records in each cluster, types of usage records, services/products to be offered to the customer, types of customer experience enhancement solutions/actions to be implemented, source of usage records, and so on. After selecting the particular cluster(s), the customer location identification module 230 identifies a geographic location for that particular cluster, using, for example, geospatial matching techniques. In some implementations, the customer location identification module 230 identifies a “work” location and a “home” location of a customer regardless of the customer's known addresses (for example, billing address, work address, etc.).

For example, as illustrated in FIG. 4B, the customer location identification module 230 identifies location 425c corresponding to cluster 420a and location 425d corresponding to cluster 420e. Similarly, FIGS. 4A and 4C illustrate locations 425a-425b and 425e-425f that are identified by the customer location identification module 230 using usage records 405a and 405c respectively. For example, the customer location identification module 230 can select a threshold number (e.g., top 3) dominant locations from the clusters, based on, for example, usage, time, and location.

### The Site Identification Module

The site identification module 240 is configured and/or programmed to identify one or more telecommunications service provider sites (for example, cell sites, hot spots, etc.) that provide coverage/service to the locations identified by the customer location identification module 230. For example, the site identification module 240 identifies at least one site associated with the identified geographic location based on a proximity of the identified geographic location from site bins associated with the site, geospatial matching, etc. Other factors used by the site identification module 240 to identify one or more telecommunications service provider sites include, but are not limited to nearest site distance from where customer most commonly calls/texts/uses data, most site usage in time and in data on the site, and so on. The site bins represent a span of area covered by the site and can be described using the following shapes: hexagon, circle, square, rectangle, or any other polygon. For example, FIG. 4A illustrates site bins 430a and 430b corresponding to locations 425a and 425b respectively. Similarly, FIG. 4B illustrates bins 430d and 430i (among bins 430c, 430e, . . . , 430n) corresponding to locations 425c and 425d respectively. FIG. 4C similarly illustrates bins 430j corresponding to locations 425e and 425f. The size of the site bins can vary depending on one or more of the following factors: location of the site, locations identified by the customer identification module, services offered by the telecommunications service provider, services/products to be offered to the customer, types of customer experience enhancement solutions/actions to be implemented, source of usage records, and so on (illustrated in FIG. 4C). For example, bins of size 168m can be created to find the associated coverage site on that bin.

### The Customer Experience Solution Selection/Ranking Module

The customer experience solution selection/ranking module 250 is configured and/or programmed to identify at least one customer experience enhancement action capable of being performed at the at least one identified site based on one or more of: the selected cluster of usage data records, the identified geographic location, or the identified site. The customer experience enhancement actions are intended to enhance overall customer experience. Examples of customer experience enhancement action include, but are not limited to: adding spectrum to the identified at least one site, removing spectrum from the identified at least one site, adding cell site proximate to the identified at least one site, removing cell site proximate to the identified at least one site, displacing cell site proximate to the identified at least one site, adding or enhancing at least one technology capability for the identified at least one site, implementing a cell split, deploying a small cell, adding/removing a sector, enhancing sector capacity, adding/removing a cell on wheels, adding/removing a tower, adding/removing hot spots, modifying capacity at the identified at least one site, and so on. Additionally or alternatively, the customer experience enhancement action comprises providing one or more of the following services to the customer (free or at reduced rates for a period of time): gaming, home security, music, videos, advertising, offers, rebates, location intelligence, upsales, partnerships with other companies, special content. For example, based on the customer's home location, the customer experience solution selection/ranking module 250 identifies offers for services such as, home security, ultra-high broadband, 4K video streaming services, restaurants in the vicinity of the identified home location, and so on.

The customer experience solution selection/ranking module 250 can select one or more customer experience enhancement actions and rank them according to one or more of the following factors: customer preferences, cost of implementation of action, timeline of implementation of action, customer location, discount offered, and so on. In some implementations, the customer experience solution selection/ranking module 250 transmits a list of selected customer experience enhancement actions to the telecommunications service provider so that one or more of the selected actions can be implemented to enhance the overall customer experience.

### Flow Diagrams

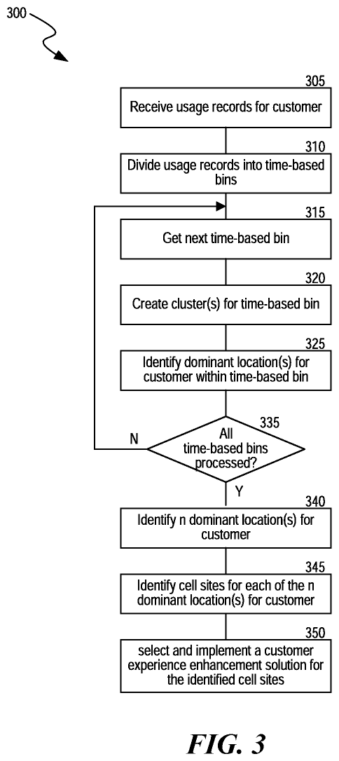

FIG. 3 is a flow diagram illustrating a process of identifying dominant customer locations in a telecommunications network. Process 300 begins at block 305 where it receives a set of usage data records associated with the customer. The records in the set of usage data records can comprise information about an associated customer location and an associated timestamp. Process 300 then proceeds to block 310 where it divides the set of usage data records into time-based bins/subsets based on, for example, the associated timestamp of the records in the set of usage data records. Then, for one or more of the time-based bins (block 315), process 300, at block 320, generates/creates a set of clusters of usage data records in the time-based bin based on, for example, the associated locations of the records. At block 325, process 300 identifies a geographic location for a selected cluster from the generated set of clusters. After processing all time-based bins (block 335), process 300 proceeds to block 340 where it identifies n dominant locations for the customer. Then, at block 345, process 300 identifies one or more sites associated with the identified geographic locations. The at least one site can be serviced by the telecommunications service provider. At block 350, process 300 selects/identifies at least one customer experience enhancement action capable of being performed at identified sites based on one or more of: the selected cluster of usage data records, the identified geographic location, or the identified site.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects can likewise be implemented in a computer-readable medium. Accordingly, the inventors reserve the right to add additional claims after filing the application to pursue such additional claim forms for other aspects of the technology.

1. A computer-implemented method for identifying customer dominant locations to enhance a customer's experience with a telecommunications service provider, the method comprising:
receiving a set of usage data records associated with the customer,
wherein records in the set of usage data records include information about an associated customer location and an associated timestamp;
dividing the set of usage data records into at least two time-based subsets based on the associated timestamp of the records in the set of usage data records;
for each time-based subset:
generating a set of clusters of usage data records in the time-based subset based on the associated locations of the records;
identifying a geographic location for a selected cluster from the generated set of clusters;
identifying at least one site associated with the identified geographic location,
wherein the at least one site is serviced by the telecommunications service provider; and
identifying at least one customer experience enhancement action capable of being performed at the at least one identified site based on one or more of: the selected cluster of usage data records, the identified geographic location, or the identified site.

2. The method of claim 1, wherein the set of clusters of usage data records is generated using k-means clustering, fuzzy clustering, partitioning, or any combination thereof.

3. The method of claim 1, wherein the at least one customer experience enhancement action comprises:
adding spectrum to the identified at least one site,
removing spectrum from the identified at least one site,
adding cell site proximate to the identified at least one site,
removing cell site proximate to the identified at least one site,
displacing cell site proximate to the identified at least one site,
adding or enhancing at least one technology capability for the identified at least one site,
cell split,
small cell deployment,
sector addition,
sector removal,
sector capacity enhancement,
cell on wheels addition,
cell on wheel removal,
tower addition,
tower removal,
hot spots addition,
hot spots removal,
capacity modification at the identified at least one site,
or any combination thereof.

4. The method of claim 1, wherein the at least one customer experience enhancement action comprises providing one or more of the following services to the customer:
gaming,
home security,
music,
videos,
advertising,
offers,
rebates,
location intelligence,
upsales,
partnerships with other companies,
or any combination thereof.

5. The method of claim 1, wherein the set of usage data records comprises data generated by one or more applications executing on a mobile device of the customer.

6. The method of claim 1, wherein the set of usage data records comprises:
location specific records (LSR),
call data records (CDRs),
timing advance values,
RF signals,
distance between the customer and at least one telecommunications network site,
strength of signal received by at least one device of the customer,
quantity of data used by the at least one device of the customer,
type of the at least one device of the customer,
or any combination thereof.

7. The method of claim 1, wherein the at least one site associated with the identified geographic location is identified based on a proximity of the identified geographic location from one or more hexagonal site bins associated with the identified at least one site.

8. The method of claim 1, wherein each of the at least two time-based subsets reflect a time period of maximum usage activity of the customer.

9. The method of claim 1, wherein the selected cluster is selected from the generated set of clusters based on a density of usage records in each cluster of the generated set of clusters.

10. The method of claim 1, wherein the at least one site associated with the identified geographic location is identified using geospatial matching.

11. At least one computer-readable medium, excluding transitory signals and containing instructions, that when executed by a processor, performs a method for identifying customer locations, the method comprising:
receiving a set of usage data records associated with the customer,
wherein records in the set of usage data records comprise information about an associated customer location and an associated timestamp;
dividing the set of usage data records into at least two time-based subsets based on the associated timestamp of the records in the set of usage data records;
for each time-based subset:
generating a set of clusters of usage data records in the time-based subset based on the associated locations of the records;
identifying a geographic location for a selected cluster from the generated set of clusters;
identifying at least one site associated with the identified geographic location,
wherein the at least one site is serviced by a telecommunications service provider; and
identifying at least one customer experience enhancement action capable of being performed at the identified at least one site based on the selected cluster of usage data records, the identified geographic location, or the identified site.

12. The at least one computer-readable medium of claim 11, wherein the set of clusters of usage data records of usage data records is generated using k-means clustering, fuzzy clustering, partitioning, or any combination thereof.

13. The at least one computer-readable medium of claim 11, wherein the at least one customer experience enhancement action comprises:
adding spectrum to the identified at least one site,
removing spectrum from the identified at least one site,
adding cell site proximate to the identified at least one site,
removing cell site proximate to the identified at least one site,
displacing cell site proximate to the identified at least one site,
adding or enhancing at least one technology capability for the identified at least one site,
cell split,
small cell deployment,
sector addition,
sector removal,
sector capacity enhancement,
cell on wheels addition,
cell on wheel removal,
tower addition,
tower removal,
hot spots addition,
hot spots removal,
capacity modification at the identified at least one site,
or any combination thereof.

14. The at least one computer-readable medium of claim 11, wherein the at least one customer experience enhancement action comprises providing one or more of the following services to the customer:
gaming,
home security,
music,
videos,
advertising,
offers,
rebates,
location intelligence,
upsales,
partnerships with other companies,
or any combination thereof.

15. The at least one computer-readable medium of claim 11, wherein the set of usage data records comprises data generated by one or more applications running on a mobile device of the customer.

16. The at least one computer-readable medium of claim 11, wherein the set of usage data records comprises:
location specific records (LSR),
timing advance values,
RF signals,
distance between the customer and at least one telecommunications network site,
strength of signal received by at least one device of the customer,
quantity of data used by the at least one device of the customer,
type of the at least one device of the customer,
or any combination thereof.

17. The at least one computer-readable medium of claim 11, wherein the selected cluster is selected from the generated set of clusters based on a density of usage records in each cluster in the generated set of clusters.

18. A computer-implemented method for identifying usage locations related to usage of a telecommunications service, the method comprising:
receiving a set of usage data records associated with a wireless device using the telecommunications service,
wherein records in the set of usage data records include information about an associated location and an associated timestamp;
dividing the set of usage data records into at least two subsets;
for at least some of the subsets:
identifying a geographic location for a generated cluster of usage data records;
identifying at least one site associated with the identified geographic location; and
identifying at least one experience enhancement action capable of being performed to improve the experience based at least on one or more of: the set of usage data records or the identified geographic location.

19. The method of claim 18, wherein a shape of the at least one site is hexagonal.

20. The method of claim 18, wherein the at least one site is associated with at least one cell site accessed by the telecommunications service.
